(19) United States
(12) Patent Application Publication
(10) Pub. No.: US 2013/0288218 A1
(43) Pub. Date: Oct. 31, 2013

(54) CARDIAC MODEL FOR SIMULATING MEDICAL PROCEDURES

(71) Applicant: MEDTRONIC CRYOCATH LP, Toronto (CA)

(72) Inventors: George D. Mallin, Quebec (CA); Jay L. Kelley, Encinitas, CA (US); Christopher D. Rolfes, St. Paul, MN (US); Alexander T. Ryan, Bayside, WI (US)

(73) Assignee: MEDTRONIC CRYOCATH LP, Toronto (CA)

(21) Appl. No.: 13/753,630

(22) Filed: Jan. 30, 2013

Related U.S. Application Data
(60) Provisional application No. 61/639,432, filed on Apr. 27, 2012.

(51) Int. Cl. G09B 23/30

(52) U.S. Cl. CPC G09B 23/303
USPC 434/268

(57) ABSTRACT

A resilient model of a heart's atria and associated vasculature is disclosed. The model is generated from CT scans of patients' with varying cardiac anatomies. The model is connected to a temperature-controlled fluid reservoir and a pump that periodically circulates fluid through the cardiac model. The model provides a visual indication of temperature change. The model may be used to simulate endocardial procedures such as pulmonary vein isolation for treatment of atrial fibrillation.

### FIELD OF THE INVENTION

The present invention relates generally to medical simulation systems and methods of use thereof.

### BACKGROUND OF THE INVENTION

Models of all or a portion of the heart are used for a variety of purposes. For example, U.S. Pat. No. 5,634,797 to Montgomery discloses a teaching aid for detecting heart defects using sonographic images. The heart model is attached to a pump unit that provides realistic flow of sonographically partially opaque fluid through the heart. The heart model may be selected from a variety of heart models, such as a normal heart or one of numerous congenitally diseased hearts.

U.S. Pat. No. 6,062,866 to Prom discloses a medical model for teaching and demonstrating invasive medical procedures such as angioplasty. The model is a plastic, transparent three-dimensional, anatomically correct representation of at least a portion of the vascular system and in a preferred embodiment would include the aorta, coronary artery, subclavian arteries, pulmonary artery and renal arteries each defining a passageway or lumen. An access port is provided so that actual medical devices, such as a guide and catheter may be inserted to the location simulated blockage. Fluid may also be introduced to simulate in vivo conditions. Simulated heart chambers of similar construction may also be attached to the aortic valve to further enhance the representation of invasive procedures.

U.S. Pat. No. 7,220,127 to Boser, et al., discloses a heart model that provides a simulative environment for lead implantation and affixation. In one embodiment, removable silicone plugs are provided at appropriate locations so that an inserted lead can be affixed to the plugs with a helical tip. A simulative venous structure is provided that has increased lubricity to facilitate the insertion and manipulation of the lead.

Each of the above references discloses a physical model of the heart. Modeling can also be performed in a numerical domain. U.S. Patent Publication 2008/262814A to Barbu et al., discloses a method for generating a four-chamber statistical heart model based on image data in 3D volumes. A 3D volume, such as a CT volume, ultrasound volume, etc., is received. A left ventricle (LV) mesh and a left atrium (LA) mesh are generated based on the 3D volume. A right ventricle (RV) mesh and a right atrium (RA) mesh are generated based on the 3D volume. Following editing of the meshes, the LV, LA, RV, and RA meshes are then used to generate a statistical heart model.

### SUMMARY OF THE INVENTION

In one aspect of the invention, a resilient, three-dimensional model of portions of a heart and associated vasculature is disclosed. The model is generated by converting a CT scan into a computer-aided design (CAD) file, then making a three-dimensional model from the CAD file. By using scans from multiple patients, cardiac models demonstrating variant anatomies such as common ostia and five pulmonary veins may be generated. The model is configured to be connectable to a temperature-controlled fluid reservoir that is periodically pumped through the cardiac model.

In another aspect of the invention, a system for simulating cardiac procedures is disclosed. The system is made up of a three-dimensional model of at least a portion of a heart having a left atrium, right atrium, pulmonary veins, a fossa ovalis, and inferior vena cava, formed of a compliant material that provides an indication of the effectiveness of a thermal treatment applied to it. The model has ports with imaging devices inserted into it. The pulmonary veins of the model are attached to a fluid reservoir that periodically circulates fluid through the cardiac model.

In yet another aspect of the invention, a method of simulating cardiac procedures is disclosed. A catheter having a thermal treatment element at its distal end is inserted into a three-dimensional model of a portion of the heart. The model is formed of a compliant material including a thermochromic pigment. The pigment provides a visual indication of the effectiveness of a thermal treatment applied to it by means of a color change. Temperature controlled-fluid is periodically circulated through the model. The catheter is advanced into contact with an interior surface of the model and a thermal treatment is applied.

### BRIEF DESCRIPTION OF THE DRAWINGS

FIG. 1 is an illustration of a CT scan of a human heart.

FIG. 2 is an illustration of a flow diagram containing the steps to convert the CT scan of FIG. 1 to a CAD drawing.

FIG. 3A is an illustration of a left atrium having a normal anatomy.

FIG. 3B is an illustration of a left atrium having a common left ostium.

FIG. 3C is an illustration of a left atrium having three right-sided pulmonary veins.

FIG. 3D is an illustration of a left atrium having three left-sided pulmonary veins.

FIG. 4 is an illustration of a cross-section of a left atrium having a normal anatomy.

FIG. 5 is an illustration of a left atrium having a common left ostium.

FIG. 6 is an illustration of a cross-section of a left atrium.

FIG. 7 is an illustration of a cross section of a right atrium

FIG. 8 is an illustration of a cross section of a left atrium showing the location of the fossa ovalis.

FIG. 9 is an illustration of a cross section of a right atrium showing the location of the fossa ovalis.

FIG. 10A is an illustration of a cardiac model.

FIG. 10B is an illustration of a camera mounted to view the interior of a cardiac model.

FIG. 11A is an illustration of a cryoablation balloon deployed in a cardiac model.

FIG. 11B is an illustration of a cryoablation balloon deployed in a cardiac model.

FIG. 12 is an illustration of an RF ablation catheter deployed in a cardiac model.

FIG. 13 is an illustration of the response of a thermochromic gel to temperature change.

FIG. 14 is an illustration of a medical simulation system.

### DETAILED DESCRIPTION OF THE INVENTION

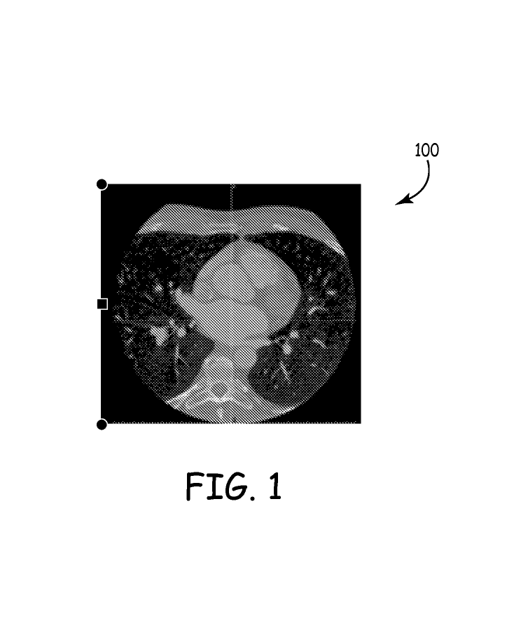

FIG. 1 shows Image 100, which is an image of a human heart made with a CT scan. The CT scan permits determination of the blood volumes of the various components of the heart, such as the left and right atrium, pulmonary veins, right and left atrial appendages, and the inferior and superior vena cava. The three-dimensional blood volumes may be reconstructed using software such as Mimics from Materialise, Inc. Numerous other imaging modalities may be used to capture a suitable image, such as magnetic resonance imaging (MRI) or rotational angiograms.

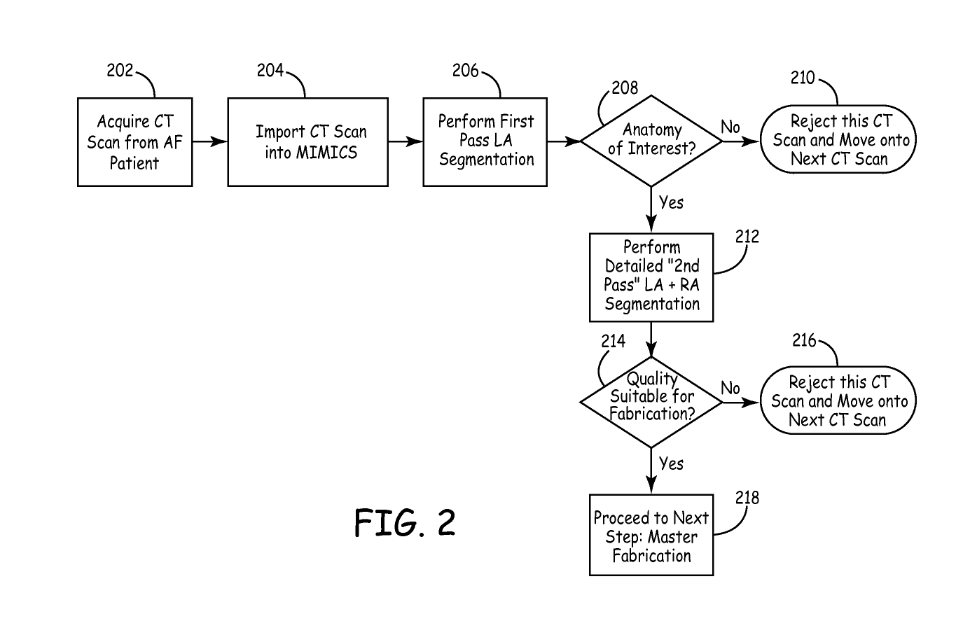

For use in simulating endocardial thermal treatment of the atria and pulmonary veins, it is beneficial to generate multiple models representative of the variations in anatomy of these structures. FIG. 2 depicts the steps used to generate a model from a CT scan of a patient suffering from atrial fibrillation (AF). In Step 202, an image such as Image 100 is acquired from a CT scan of an AF patient. In Step 204, the image is imported into the analysis software such as Mimics. In Step 206, a first-pass left atrial (LA) segmentation is performed by Mimics. In Step 208, a data file created by Step 206 is reviewed to determine if the anatomy is of interest to generate a full model. If no, Step 210 rejects this CT scan and returns to Step 202 to review a CT scan from another patient. If yes, Step 212 performs a detailed second pass in which the Left Atrium and Right Atrium are segmented in the data file. In Step 214, the file is reviewed to determine if is suitable for fabricating a three-dimensional model. If no, Step 216 rejects the file and returns to Step 202. If yes, Step 218 generates a file that may be edited to generate a file for fabricating a three-dimensional model.

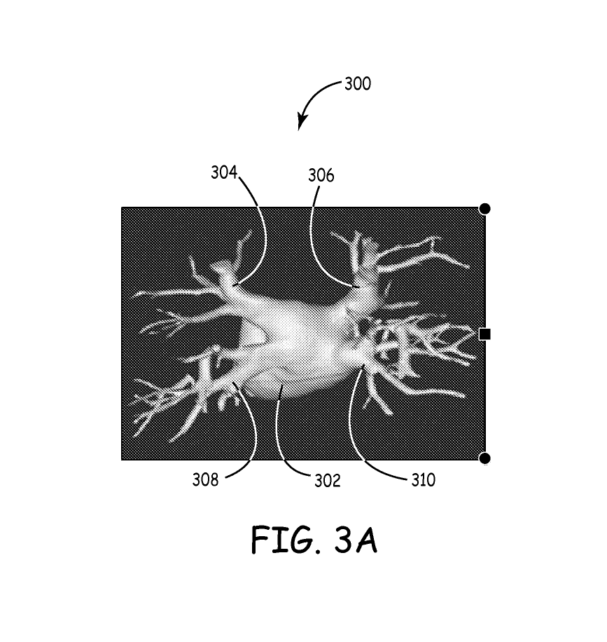

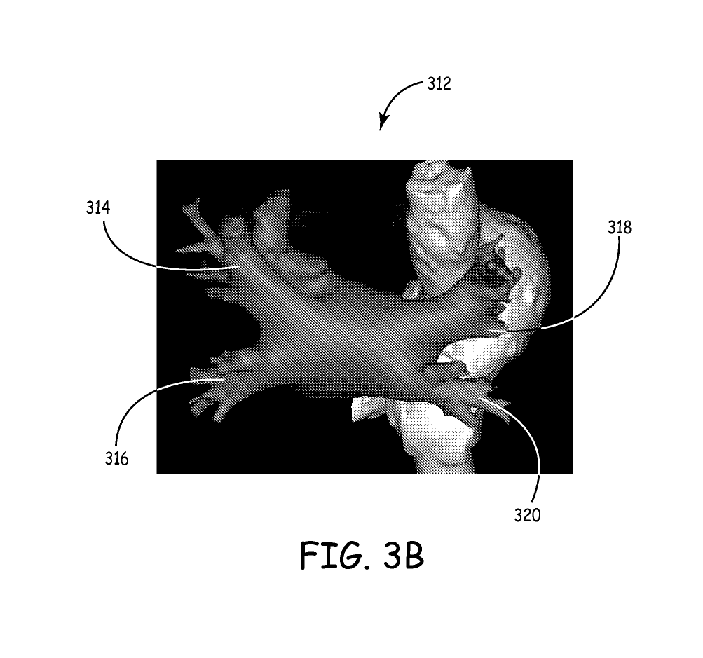

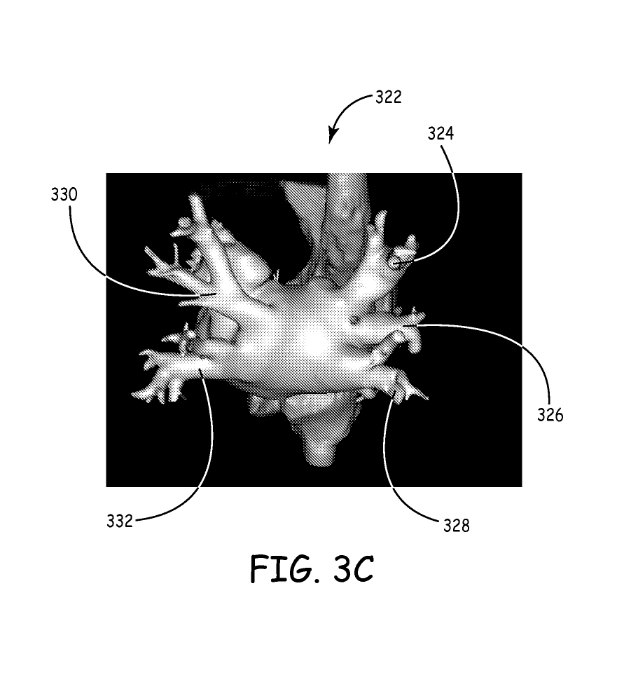

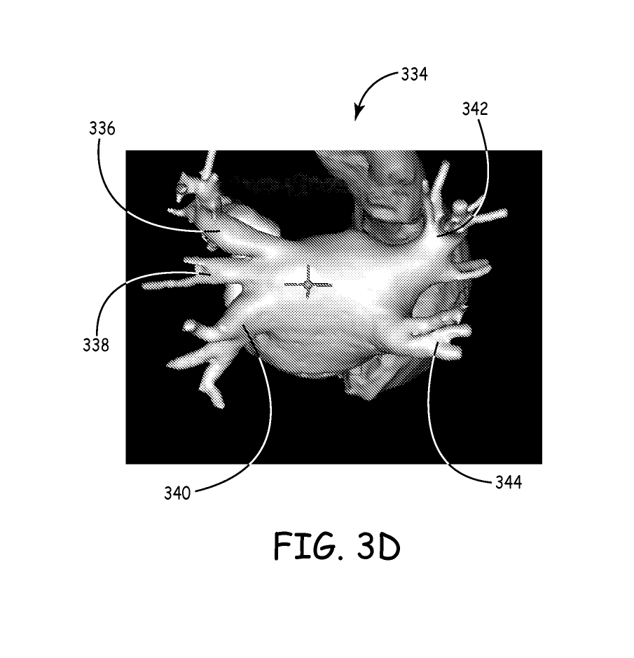

FIGS. 3A-3D depict images generated from the CAD file generated by Step 218 of the flow chart of FIG. 2. Each image is a superior-posterior view of the left atrium of the model. FIG. 3A is of a “typical” or “normal” anatomy in which four pulmonary veins separately enter the left atrium. FIG. 3A shows Left Atrium 302, Left Inferior Pulmonary Vein (LIPV) 308, Left Superior Pulmonary Vein (LSPV) 304, Right Inferior Pulmonary Vein (RIPV) 310, and Right Superior Pulmonary Vein (RSPV) 306.

FIG. 3B shows an anatomy in which the left pulmonary veins share a common ostium. Left Atrium 312 is entered by Left Inferior Pulmonary Vein (LIPV) 308, Left Superior Pulmonary Vein (LSPV) 304, Right Inferior Pulmonary Vein (RIPV) 310, and Right Superior Pulmonary Vein (RSPV) 306.

FIG. 3C shows an anatomy in which the patient has three right-side pulmonary veins. Left Atrium 322 is entered by Left Inferior Pulmonary Vein (LIPV) 332, Left Superior Pulmonary Vein (LSPV) 330, Right Inferior Pulmonary Vein (RIPV) 328, and Right Superior Pulmonary Vein (RSPV) 324. It is also entered by Right Middle Pulmonary Vein 326.

FIG. 3D show an anatomy in which the patient has three left-side pulmonary veins. Left Atrium 334 is entered by Left Inferior Pulmonary Vein (LIPV) 340, Left Superior Pulmonary Vein (LSPV) 336, Right Inferior Pulmonary Vein (RIPV) 344, and Right Superior Pulmonary Vein (RSPV) 342. It is also entered by Left Middle Pulmonary Vein 338.

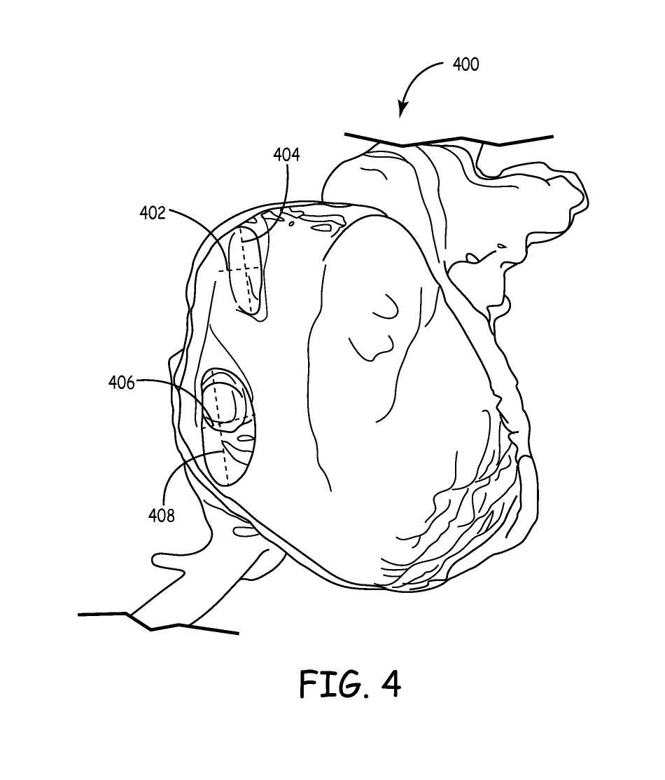

Using these CAD files, the dimensions of certain anatomical features were determined. FIG. 4 shows the determination of the left pulmonary vein dimensions for a typical left atrial anatomy. It shows Left Atrial Cross-Section 400. First Anterior-Posterior Axis 402 and First Inferior-Superior Axis 404 are the dimensions for the left superior pulmonary vein. Second Anterior-Posterior Axis 406 and Second Inferior-Superior Axis 408 are the dimensions for the left inferior pulmonary vein.

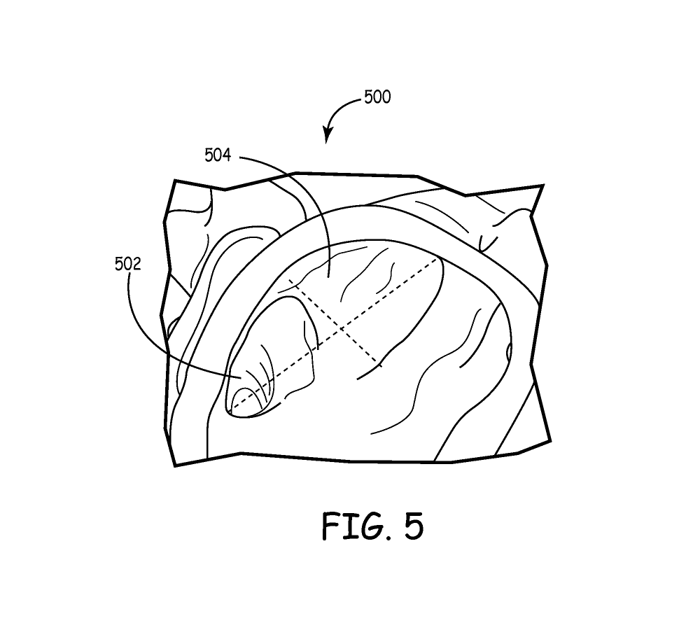

FIG. 5 shows the axes used to determine the dimensions of one of a left common ostium, one of the variant anatomies in the set of models. It shows Common Left Ostium 500, with dimensions determined using Inferior-Superior Axis 502 and Anterior-Posterior Axis 504.

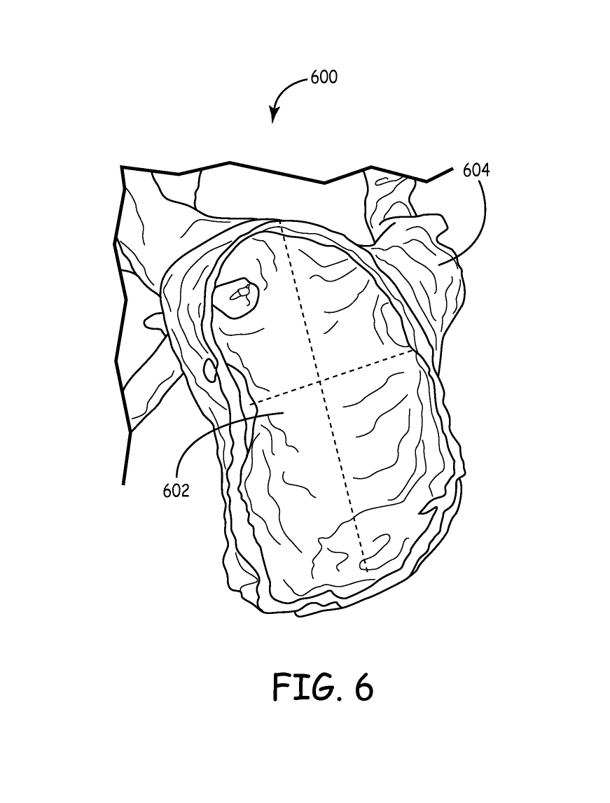

FIG. 6 shows the axes used to determine the dimensions of the left atrium. Shown on FIG. 6 is Left Atrium 600, with Anterior-Posterior Axis 602 and Inferior-Superior Axis 604.

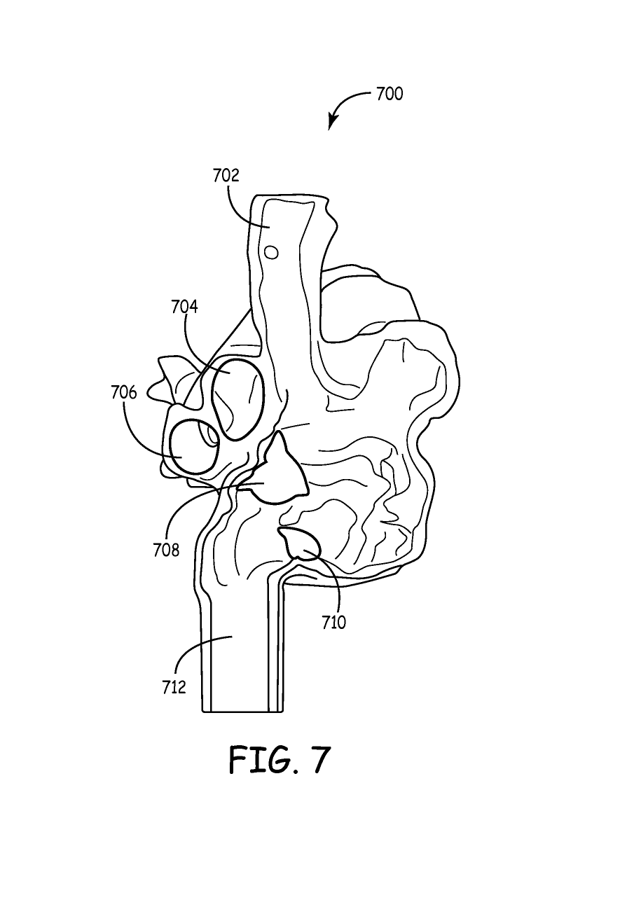

FIG. 7 is a cross section of Right Atrium 700. It shows additional aspects of the cardiac structures that are present in the CAD model generated by the steps described above. The model includes Superior Vena Cava (SVC) 702 and Inferior Vena Cava (IVC) 712. Right Inferior Pulmonary Vein (RIPV) 706 and Right Superior Pulmonary Vein (RIPV) 704 are also visible in this view. The model also includes Coronary Sinus 710. The CAD file is edited to locate the Fossa Ovalis and Septum 708. The location of the Fossa Ovalis was determined through consultation of peer reviewed literature as well as measurements on perfusion fixed human hearts. The measurements and findings were then translated onto the 3D model to determine where the Fossa Ovalis should be. A pronounced indentation in the model defines the Fossa, imitating the pocket experienced clinically while a transseptal puncture site is being established.

Table 1 below summarizes the dimensions of various cardiac anatomical features for four different human subjects as determined by the methods described above. All dimensions are in millimeters.

TABLE 1

| | LA | LA | LA | LSPV | LIPV | RSPV | RIPV | RMPV | LMPV | Left |
|---|---|---|---|---|---|---|---|---|---|---|
| ID | length | AP | SI | (AP × SI) | (AP × SI) | (AP × SI) | (AP × SI) | (AP × SI) | (AP × SI) | common |
| P01 | 62.24 | 35.17 | 41.24 | 11.3 × 23.1 | 14.5 × 18.1 | 21.7 × 17.8 | 18.2 × 18.0 | | | 19.9 × 39.0 |
| P03 | 61 | 33.4 | 54.6 | 7.0 × 16.8 | 10.1 × 21.3 | 17.4 × 17.5 | 20.9 × 23.9 | 15.0 × 16.5 | | |
| P06 | 52.5 | 45.9 | 63.3 | 7.4 × 23.6 | 11.3 × 20.0 | 16.6 × 24.7 | 23.7 × 22.5 | | | |
| P08 | 60.7 | 32.9 | 69.3 | 9.5 × 18.1 | 14.4 × 20.1 | 22.1 × 27.2 | 22.7 × 22.3 | | 13.7 × 10.6 | |

Table 1 may be interpreted using the following key:
LA: Left Atrium
LSPV: Left Superior Pulmonary Vein
LIPV: Left Inferior Pulmonary Vein
RSPV: Right Superior Pulmonary Vein
RIPV: Right Inferior Pulmonary Vein
RMPV: Right Middle Pulmonary Vein (for subjects with three right-side pulmonary veins)
LMPV: Left Middle Pulmonary Vein (for subjects with three left-side pulmonary veins)
Left Common: Left common ostium
AP: Anterior-posterior axis
SI: Superior-inferior axis

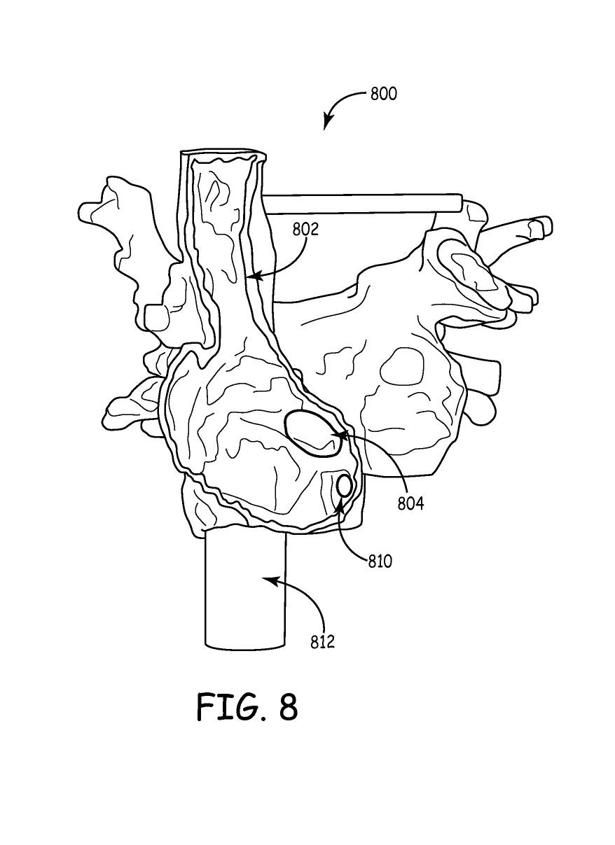

FIG. 8 is a cross section of Left Atrium 800. It shows SVC 802 and IVC 812. Coronary Sinus 810 is also depicted. Fossa Ovalis 804 is located on the drawing according to the methods described in connection with FIG. 7.

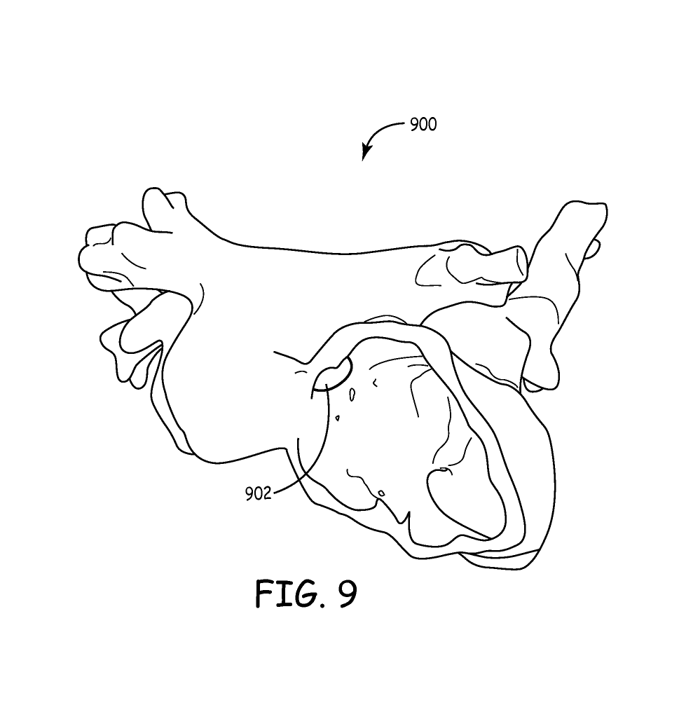

FIG. 9 is a cross section of Right Atrium 900 showing Fossa Ovalis 902.

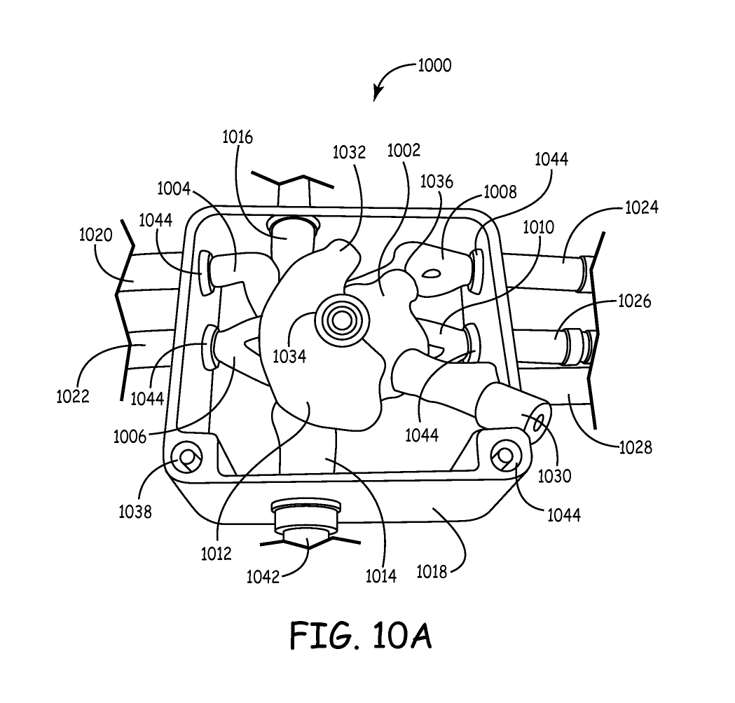

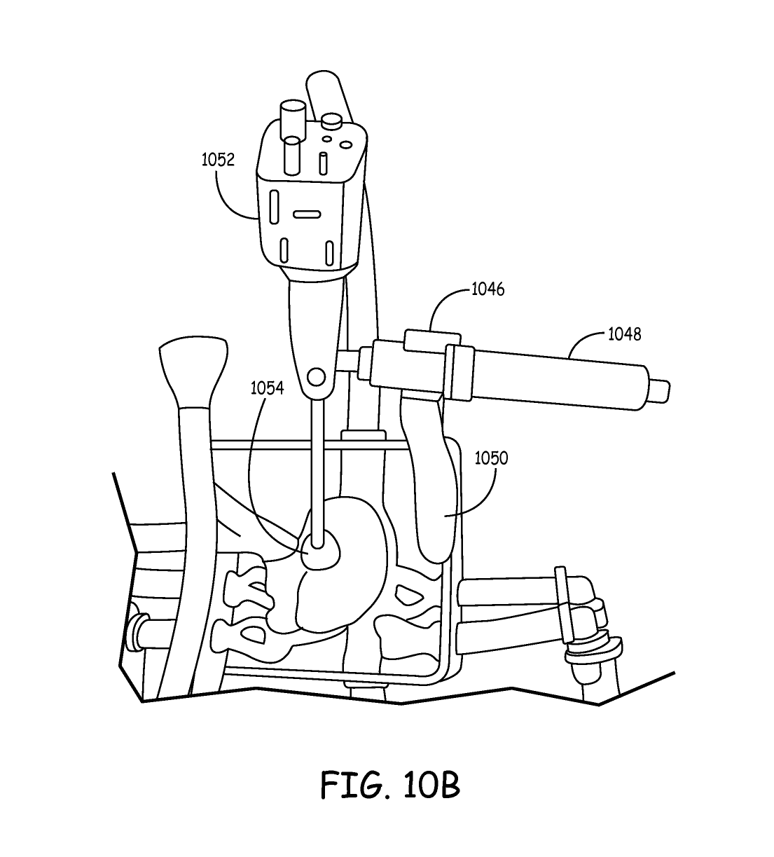

FIG. 10A shows a fabricated Cardiac Model 1000. The CAD drawings such as those of FIG. 3A-3D are further edited to incorporate ports for the insertion of cameras into the completed model. The model is also edited to extend the branches of the pulmonary veins for the attachment of tubing and quick disconnects to their ends. A physical, three-dimensional model is then fabricated.

In this embodiment of the model, it is fabricated from silicone with a durometer of approximately 30 in the Shore A hardness scale. The wall thickness of the model is approximately 3 mm. Greater fidelity to the actual compliance of a human heart could be achieved with a reduced wall thickness or through the use of lower-durometer silicone. The inside of the heart model is coated with a glass microbead surface, which allows for the model to be lubricious while using pure water as its pumping fluid.

In this embodiment, the silicone contains a thermochromic pigment. The pigment is binary; that is, below a certain temperature it is dark, and above a certain temperature it is not. The transition temperature for the pigment in this embodiment is approximately 10 degrees C., but response temperatures all the way down to −10 C are possible. This low-temperature threshold permits the user to observe the effectiveness of cryogenic procedures performed on the cardiac model. The pigment is mixed with the silicone prior to molding. The final percent by weight in the model is about 0.05%. More than one pigment with different transition temperatures could be mixed into the same silicone, allowing color changes at multiple temperature thresholds. A thermochromic pigment that changed color at a high temperature (50 C, for example), would allow for lesion visualization while using RF energy.

In FIG. 10A, the Cardiac Model 1000 is placed within Fixture 1018. The model has the following anatomical features visible on its exterior: Left Atrium 1002 and Right Atrium 1012; Left Atrial Appendage 1036 and Right Atrial Appendage 1032; Right Superior Pulmonary Vein 1004 and Right Inferior Pulmonary Vein 1006; Left Superior Pulmonary Vein 1008 and Left Inferior Pulmonary Vein 1010; Inferior Vena Cava 1014 and Superior Vena Cava 1016. A First Hemostatic Valve 1042 attaches to Fixture 1018 at the point where Inferior Vena Cava 1014 plugs into Fixture 1018. A similar hemostatic valve (not shown) is attached to Fixture 1018 at the point where Superior Vena Cava 1016 attaches to Fixture 1018. The pulmonary veins on the model may be died with an opaque material to permit better visualization of the pulmonary vein ostia when performing a simulated endocardial procedure. Each of the pulmonary veins in Cardiac Model 1000 is removably attached to Fixture 1000 with Quick-Connect Coupling 1044.

The model in FIG. 10A has First Camera Port 1030 and Second Camera Port 1034. In this embodiment, the camera ports are positioned to provide Left Anterior Oblique and Anterior-Posterior views. Alternate locations for the camera ports may be used to provide additional or different views of the interior of the model during simulated cardiac procedures. For example, a camera location positioned to look directly down the axes of the pulmonary veins may assist in learning pulmonary vein isolation procedures. A camera port providing a view of the septum would assist in training on transseptal crossing procedures. The model may be fabricated with a left atrium only in order to facilitate placement of additional camera ports. Fixture 1018 contains First Mounting Post 1038 and Second Mounting Post 1040 for mounting a camera to view the interior of the cardiac model through First Camera Port 1030 and Second Camera Port 1014.

In this embodiment, the model's fossa ovalis (not shown) is pre-punctured with a single puncture. When performing a simulated endocardial procedure that requires a transseptal puncture, the user maneuvers the device (such as an ablation catheter) to locate the pre-punctured model fossa ovalis. Other embodiments may vary the pre-punctured fossa ovalis. For example, the model may contain multiple pre-punctured locations. This would permit a user to assess the significance of puncturing in a particular place on the septum. They would be able to try both locations and see how the puncture location changes the approach angles to the veins of a treatment element such as the distal end of a catheter.

Fixture 1018 contains fluid connections to permit fluid to be pumped through the cardiac model. Inflow connections 1020, 1022, 1024, and 1026 each enter Fixture 1018 and terminate in a quick-connect fitting to which each of the model's pulmonary veins may be connected. Outflow connection 1028 removes fluid from the model and attaches to the Cardiac Model 1000 at approximately the location where the mitral valve would be if the model contained that cardiac structure.

FIG. 10A depicts a single three-dimensional model of a single cardiac anatomy. Three-dimensional models of any of the variant cardiac anatomies may be fabricated. In order to use them, is only necessary to detach Cardiac Model 1000 from Fixture 1018 by disconnecting the pulmonary veins and the outflow connection. A different model may then be installed into Fixture 1000 by connecting its pulmonary veins and outflow connection to Fixture 1018.

Additional anatomical, thermal, and electrical features may be incorporated into Cardiac Model 1000 to allow it to more accurately represent a patient's heart. For example, an additive could be included in the silicone to make Cardiac Model 1000 electrically conductive. This would provide a more accurate simulation environment for the use of RF ablation catheters in the model. As well, the thermal conductivity of the model could be modified to accurately correspond to the thermal conductivity of cardiac tissue. This would also increase the fidelity of the model when used to simulate thermal treatments of the heart.

FIG. 10B depicts the Cardiac Model 1000 with a Camera 1048 mounted to observe the interior of Cardiac Model 1000 through First Camera Port 1034. Articulating Arm 1050 is attached to First Mounting Post 1038 (not visible in FIG. 10B). Articulating Arm 1050 terminates in Clamp 1046. Claim 1046 retains Light Source 1048. Light Source 1048 is attached to Camera 1052. The video output of Camera 1048 may be transmitted either wirelessly or through an appropriate cable to a video monitor (not shown).

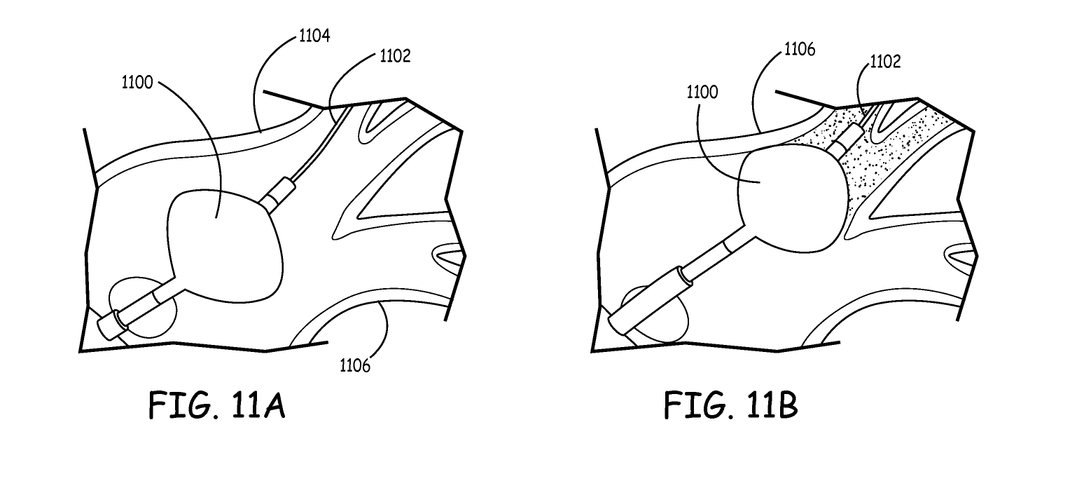

FIGS. 11A and 11B depict the use of the model to simulate a pulmonary vein isolation using a cryoablation device. In FIG. 11A, a cryoablation balloon catheter such as Medtronic CryoCath LP's ARCTIC FRONT® cryoablation balloon passes over Guidewire 1104 as it approaches Pulmonary Vein 1102. The cryoablation balloon has previously been passed through the SVC or IVC in the model into the right atrium, through the fossa ovalis in the model, and into the model's left atrium. In FIG. 11B, the cryoablation balloon is then pressed against the pulmonary vein ostium to occlude Pulmonary Vein 1104 from Left Atrium 1106. Occlusion of the Pulmonary Vein 1104 is verified by injecting a colored dye through a guidewire lumen (not shown). The dye can be visually observed using the image transmitted from the cameras.

Occlusion verification can also be accomplished clinically by observing real-time pressure waveforms. Following occlusion, the cryoablation balloon is cooled to its operating temperature, and a visual indication of its effectiveness provided by the color change of the thermochromic additive.

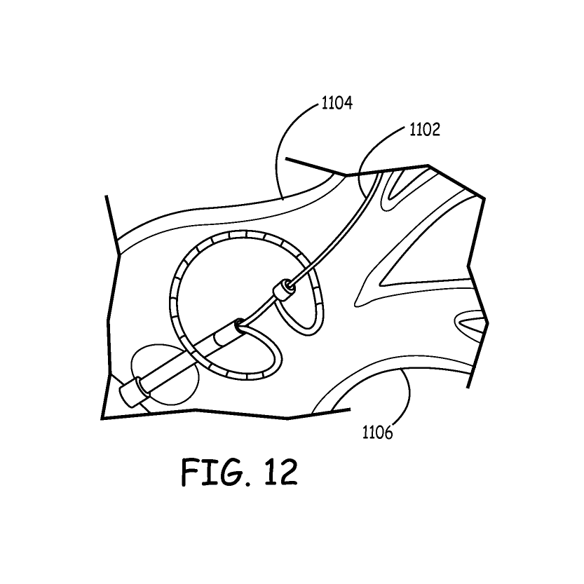

FIG. 12 depicts the use of the model to simulate an RF ablation procedure. In this example, RF ablation device 1200, such as the Medtronic Ablation Frontiers PVAC® pulmonary vein ablation catheter is inserted into the model's left atrium. The RF ablation device is then pressed against the ostium of a pulmonary vein in the model, energized with RF energy. The RF energy is transmitted to the material of the model. If a thermochromic material that is responsive to high temperatures has been added to the model, the effectiveness of the RF ablation may be observed by the color change of the thermochromic material.

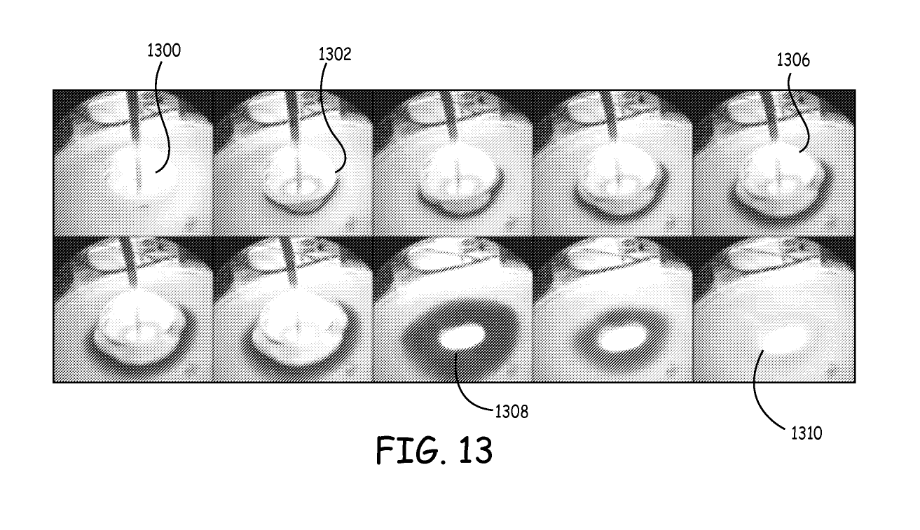

FIG. 13 is a series of images demonstrating the response of the resilient cardiac model material containing thermochromic material to a cryoablation balloon. Image 1300 shows an inflated cryoablation balloon placed against the resilient material. In image 1302, the balloon has been cooled to its operating temperature of −50 degrees C. As the balloon cools the cardiac model material, the thermochromic material within it begins to change color, as can be observed in Image 1302. After the balloon has been held in contact with the cardiac model material for four minutes, a typical duration of an ablation of a single location in the atrium, Image 1308 shows a more widespread color change, indicating that a larger area of the cardiac model material has been cooled below the thermochromic material's temperature threshold. After the cryoablation balloon has been removed from contact with the cardiac model material, the cardiac model material returns to a temperature above the thermochromic material's color change threshold, and the color reverts to that of the cardiac model material. Image 1310 shows the reversal of the color change of the thermochromic material after the temperature of the cardiac model material has risen.

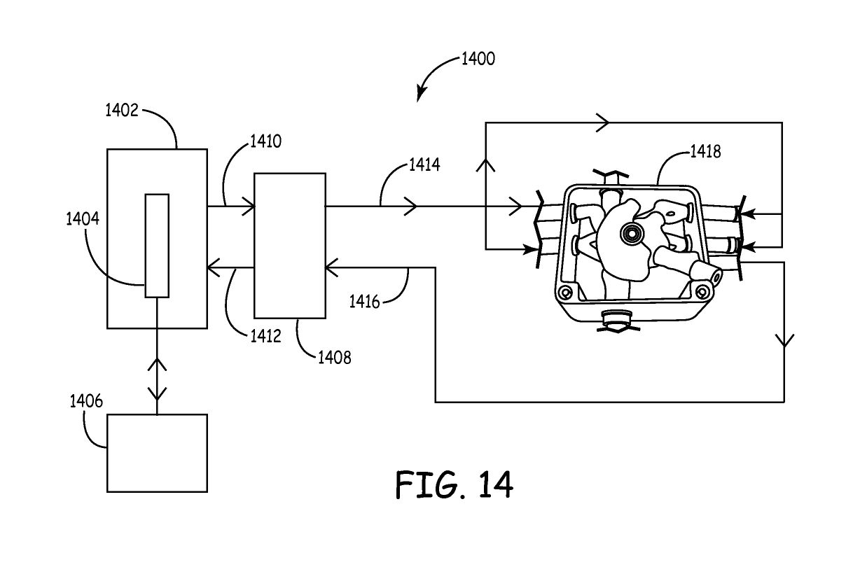

In order to accurately reproduce the cardiac environment when simulating an endocardial procedure, the heart model is incorporated into a system that periodically pumps temperature-controlled fluid through it. FIG. 14 is a block diagram of the thermal and fluid components of this system. FIG. 14 depicts Cardiac Modeling System 1400. Cardiac Modeling System 1400 includes the Cardiac Model and Fixture from FIG. 10A, depicted here as Cardiac Model 1418. It includes Fluid Reservoir 1402, which contains within it Heating Element 1404. Heating Element 1404 is in electrical communication with Temperature Controller 1406. Fluid Reservoir 1402 contains a working fluid (not shown), which may be distilled water, a saline solution, or any other fluid chosen to represent blood circulating through the heart. Temperature Controller typically maintains the temperature of the working fluid at 37 degrees C., corresponding to the temperature of blood in a human. The Fluid Reservoir 1402 is in fluid communication with Pump 1408. Pump 1408 draws fluid from the Fluid Reservoir 1402, periodically pumps fluid into the pulmonary veins of the Cardiac Model 1418 through Fluid Output Line 1414. The pump extracts fluid from Cardiac Model 1418 through Fluid Return Line 1416, which is in fluid communication with Cardiac Model 1418. A pump with an output of 5 liters/minute can simulate blood flow through a human heart.

Pump 1408 may be a bellows pump generating 66 pulses per minute. When this pump operates, the flexible Cardiac Model 1418 moves with each beat, thereby adding tactile feedback when the catheter is against the heart wall. The pump may operate at a fixed frequency, or the frequency may be user-selectable. There are other means to generate the periodic flow through the Cardiac Model 1418. For example, a water column of constant height could be fluidly connected to the Fluid Reservoir 1402 to generate a desired pressure, and a valve located between the Fluid Reservoir 1402 and Cardiac Model 1418 to start and stop the flow. Alternatively, centrifugal pump and a peristaltic pump could be combined. The centrifugal pump would produce a continuous component of flow, and a peristaltic pump would add a pulsatile effect. Finally, a compliance chamber could store a small volume of air above the fluid reservoir. The pressure in the compliance chamber could be controlled by a feedback controller, such as a proportional-integral-derivative (PID) controller that controls the pressure in the compliance chamber by operating a proportional valve connected to high-pressure air.

The Cardiac Modeling system may be used to simulate an ablation procedure in the model's atria. One such procedure is pulmonary vein isolation, which is considered of ablation treatment for atrial fibrillation. The general procedure for use of a catheter having a thermal treatment element at its distal end into the model's left atrium and to activate the catheter's treatment element to performan an ablation. In the case of a cryoablation balloon catheter that travels over a guidewire, the user steers a guidewire into a pulmonary vein, inflate the balloon catheter inside the left atrium, advances the balloon along the guidewire to achieve vein occlusion, and then freeze the balloon to create a circumferential lesion. This model is meant to serve as a tool for physician training of this procedure, as well as for design validation and catheter development.

It should be understood that numerous other configurations for the present invention could be realized. The foregoing discussion describes merely exemplary embodiments illustrating the principles of the present invention, the scope of which is recited in the following claims. Those skilled in the art will readily recognize from the description, claims, and drawings that numerous changes and modifications can be made without departing from the spirit and scope of the invention.

1. A medical model comprising:
a. A three-dimensional model of at least a portion of a heart having a left atrium, right atrium, pulmonary veins, a fossa ovalis, and inferior vena cava;
b. Said three-dimensional model formed of a compliant material that provides an indication of the effectiveness of a thermal treatment applied to it;

2. The model of claim 1 wherein the pulmonary veins comprise three left-sided pulmonary veins.

3. The model of claim 1 wherein the pulmonary veins comprise three right-sided pulmonary veins.

4. The model of claim 1 wherein the pulmonary veins have a common left ostium.

5. The model of claim 1 wherein the pulmonary veins are detachably connectable to a fluid reservoir.

6. The model of claim 5 wherein the fluid reservoir is in fluid communication with a pump, said pump operable to periodically circulate fluid through the three-dimensional model.

7. The model of claim 1, wherein the indication of the effectiveness of thermal treatment is a visual indication.

8. The model of claim 7, wherein the visual indication is a temporary color change that occurs when the temperature of the model is below a first threshold temperature.

9. The model of claim 7, wherein the visual indication is a temporary color change that occurs when the temperature of the model is above a second threshold temperature.

10. The model of claim 7, wherein the visual indication is a temporary color change that occurs when the temperature of the model is below a first threshold temperature and a temporary color change that occurs when the temperature of the model is above a second threshold temperature.

11. The model of claim 1, further comprising a port for the insertion of an imaging device to view the interior of the model.

12. A system for simulating medical procedures comprising:
a. A three-dimensional model of at least a portion of a heart having a left atrium, right atrium, pulmonary veins, a fossa ovalis, and inferior vena cava;
b. the model having ports with imaging devices inserted therein;
c. the model formed of a compliant material that provides an indication of the effectiveness of a thermal treatment applied to it;
d. The pulmonary veins of said model detachably connected to a fluid reservoir containing a saline solution;
e. The fluid reservoir connected to a pump that periodically circulates fluid through the model;
f. The fluid reservoir in thermal communication with a heating element;
g. the heating element in electrical communication with a controller that maintains a temperature in the fluid reservoir.

13. The system of claim 12, further comprising a plurality of three-dimensional models, each model dimensioned and configured to represent a different pulmonary vein anatomy, said pulmonary vein anatomies selected from the group consisting of normal pulmonary vein anatomy, common left ostium, three left-sided pulmonary veins, or three right-sided pulmonary veins.

14. The system of claim 12, wherein the pump circulates the saline solution at a fixed frequency;

15. The system of claim 12, wherein the pump circulates the saline solution at a selectable frequency;

16. The system of claim 12, further comprising a catheter having a distal end, the catheter having a thermal treatment element located at the distal end.

17. The system of claim 12, wherein the indication of the effectiveness of thermal treatment is a temporary visual indication of a temperature change.

18. A method of simulating a medical procedure, comprising:
a. Inserting a catheter having a thermal treatment element at a distal end of the catheter into a three-dimensional model of at least a portion of a heart having a left atrium, right atrium, pulmonary veins, a fossa ovalis, and inferior vena cava;
b. Said model having a borehole with an imaging device inserted therein;
c. said model formed of a compliant material that provides a visual indication of the effectiveness of a thermal treatment applied to it;
d. Circulating fluid periodically through said model;
e. advancing said catheter into contact with an interior surface of the model;
f. applying a thermal treatment through the thermal treatment element;

19. The method of claim 18, further comprising the step of observing an image of the interior of the model transmitted by the imaging device.

20. The method of claim 18 further comprising the step of selecting the three-dimensional model from a plurality of three-dimensional models, each model dimensioned and configured to represent a different pulmonary vein anatomy, said pulmonary vein anatomies selected from the group consisting of normal pulmonary vein anatomy, common left ostium, three left-sided pulmonary veins, or three right-sided pulmonary veins.

21. The method of claim 20, further comprising the step of creating the plurality of three-dimensional models from a CT scan of a patient and reconstructing the scan into three-dimensional volumes.
